(19) United States
(12) Patent Application Publication
(10) Pub. No.: US 2022/0279532 A1
(43) Pub. Date: Sep. 1, 2022

(54) METHODS AND NODES FOR MANAGING CROSS-LINK INTERFERENCE IN IAB NODES

(71) Applicant: TELEFONAKTIEBOLAGET LM ERICSSON (PUBL), Stockholm (SE)

(72) Inventors: Filip Barac, HUDDINGE (SE); Yezi Huang, TÄBY (SE); Oumer Teyeb, SOLNA (SE)

(21) Appl. No.: 17/626,829

(22) PCT Filed: Jul. 13, 2020
(86) PCT No.: PCT/IB2020/056585

§ 371 Date: Jan. 13, 2022

Related U.S. Application Data
(60) Provisional application No. 62/874,111, filed on Jul. 15, 2019.

(51) Int. Cl. H04W 72/12

(52) U.S. Cl. CPC H04W 72/1231; H04W 72/1247

(57) ABSTRACT

A method in a first IAB node is provided. The method comprises: receiving an indication of resource allocation from a second network node, the indication indicating whether resources are allocated for a backhaul link or an access link; performing cross- link interference (CLI) management based on the indication of resource allocation.

### RELATED APPLICATIONS

The application claims the benefits of priority of U.S. Provisional Patent Application No. 62/874,111, entitled “Methods and nodes for cross-link interference management for IAB nodes” and filed at the United States Patent and Trademark Office on Jul. 15, 2019, the content of which is incorporated herein by reference.

### TECHNICAL FIELD

The description generally relates to wireless communication systems and more specifically to managing cross-link interference in an Integrated Access and Backhaul (IAB) architecture.

### BACKGROUND

Integrated Access and Backhaul Overview

Densification via the deployment of more and more base stations (be macro or micro base stations) is one of the mechanisms that can be employed to satisfy the ever-increasing demand for more and more bandwidth/capacity in mobile networks. Due to the availability of more spectrum in the millimeter wave (mmw) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative. One such solution is an Integrated Access and Backhaul (IAB) network, where the operator can utilize part of the radio resources for the backhaul link.

IAB has been studied earlier in Third Generation Partnership Project (3GPP) in the scope of Long Term Evolution (LTE) Release-10 (Rel-10). In that work, an architecture was adopted where a Relay Node (RN) has the functionality of an LTE eNodeB (eNB) and User Equipment (UE) modem. The RN is connected to a donor eNB which has a S1/X2 proxy functionality hiding the RN from the rest of the network. That architecture enabled the Donor eNB to also be aware of the UEs behind the RN and hide any UE mobility between Donor eNB and Relay Node on the same Donor eNB from the Core Network (CN).

During the Rel-10, other architectures were also considered, e.g. where the RNs are more transparent to the Donor gNB and allocated a separate stand-alone Packet/Serving Gateway node.

For New Radio (NR), similar architecture option can also be considered. One potential difference compared to LTE (besides lower layer differences) is that a gNB-CU/DU (Centralized Unit/Distributed Unit) split is defined for NR, which allows a separation of time critical Radio Link Control (RLC)/Media Access Control (MAC)/Physical (PHY) protocols from less time critical Radio Resource control (RRC)/Packet Data convergence Protocol (PDCP) protocols. Such a split could also be applied for the IAB case. Other differences anticipated in NR as compared to LTE with regards to IAB is the support of multiple hops as well as the support of redundant paths.

FIG. 1 illustrates a multi-hop deployment in an IAB network, where the IAB donor node (or IAB donor) has a wired connection to the core network and the IAB relay nodes (or IAB nodes) are wirelessly connected using NR to the IAB donor, either directly or indirectly via another IAB node. The connection between IAB donor/node and UEs is called access link, whereas the connection between two IAB nodes or between an IAB donor and an IAB node is called backhaul link.

FIG. 2 illustrates IAB terminology in adjacent hops. For example, as shown in FIG. 2, the adjacent upstream node which is closest to the IAB donor node of an IAB node is referred to as a parent node of the IAB node. The adjacent downstream node which is further away from the IAB donor node of an IAB node is referred to as a child node of the IAB node. The backhaul link between the parent node and the IAB node is referred to as parent (backhaul) link, whereas the backhaul link between the IAB node and the child node is referred to as child (backhaul) link.

Integrated Access and Backhaul Architectures

During the study item phase of the IAB work (see for example 3GPP technical report (TR) 38.874), it has been agreed to adopt a solution that leverages the CU/DU split architecture of NR, where the IAB node will be hosting a DU part that is controlled by a central unit. The IAB nodes also have a Mobile Termination (MT) part that they use to communicate with their parent nodes.

The specifications for IAB strive to reuse existing functions and interfaces defined in NR. In particular, MT, gNB-DU, gNB-CU, User Plane function (UPF), Access and Mobility Function (AMF) and Session Management Function (SMF) as well as the corresponding interfaces NR Uu (between MT and gNB), F1, NG, X2 and N4 are used as baseline for the IAB architectures..

FIG. 3 shows a reference diagram for IAB architecture, in standalone mode (for example), which contains one IAB-donor and multiple IAB-nodes. The IAB-donor is treated as a single logical node that comprises a set of functions such as gNB-DU, gNB-CU-CP, gNB-CU-UP and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

A new protocol layer called Backhaul Adaptation Protocol (BAP) has been introduced in the IAB nodes and the IAB donor. The BAP is used for routing of packets to the appropriate downstream/upstream node and mapping the UE bearer data to the proper backhaul RLC channel (as well as between ingress and egress backhaul RLC channels in intermediate IAB nodes) to satisfy the end to end Quality of Service (QoS) requirements of bearers.

Cross-link interference

Wireless cellular network coverage consists of cells, where each cell is defined by a certain coverage area of a network node (NN). The NN communicates with UEs in the network wirelessly, using the access resources.

The communication is carried out in either paired or unpaired spectrum. In paired spectrum, the downlink (DL) and uplink (UL) directions are separated in frequency, called Frequency Division Duplex (FDD). In unpaired spectrum, the DL and UL use the same spectrum, called Time Division Duplex (TDD). In TDD, the DL and UL are separated in the time domain, typically with a guard period (GP) between them. There is one GP at a DL-to-UL switch and one GP at an UL-to-DL switch. The GP at the UL-to-DL switch only needs to give enough time to allow the NN and the UE to switch between reception and transmission, it is typically small, and can be neglected in the following description. The GP at the DL-to-UL switch must be sufficiently large to allow a UE to receive a (time-delayed) DL grant scheduling the UL and transmit the UL signal with proper timing advance (compensating for the propagation delay) such that it is received in the UL part of the frame at the NN (in fact, the GP at the UL-to-DL switch is created with an offset to the timing advance). Thus, the GP should be larger than two times the propagation time towards a UE at the cell edge, otherwise, the UL and DL signals in the cell will interfere. Because of this, the GP is typically chosen to depend on the cell size such that larger cells (i.e. larger inter-site distances) have a larger GP and vice versa.

The GP reduces DL-to-UL interference between NNs by allowing a certain propagation delay between cells without having the DL transmission of a first NN entered the UL reception of a second NN. In a typical macro network, the DL transmission power can be on the order of 20 dB larger than the UL transmission power. Hence, if the UL reception is interfered by the DL of other cells, so called cross-link interference (CLI), the UL performance can be seriously degraded. Because of the large transmit power discrepancy between UL and DL and/or propagation conditions, CLI can be detrimental to system performance not only for the co-channel case (where DL interferes UL on the same carrier) but also for the adjacent channel case (where DL transmission of one carrier interferes with UL reception on an adjacent carrier). By aligning UL and DL periods so that they do not occur simultaneously, the interference between UL and DL can be reduced. Typically, operators with adjacent TDD carriers also synchronize their TDD UL/DL patterns to avoid adjacent CLI.

In the IAB context, the resources can be classified as access and backhaul. The access resources are used for serving regular UEs (as in the non-IAB case) — here, the access IAB node serves regular UEs, although the UE-destined traffic may be delivered to the access IAB node via several wireless hops (i.e. backhauled). The traffic terminated at the MT part of the IAB node (e.g. Signaling Radio Bearer (SRB) traffic to the MT) is also carried via access resources. Meanwhile, the backhaul resources are used for passing the CP or UE-destined UP traffic between IAB nodes. As a note, an IAB node connects to its parent node(s) via the MT, meaning that backhaul traffic to and from the parent goes through the IAB node's MT functionality. Furthermore, it is expected that there will be no UP traffic terminated at the MT. The CP traffic terminated at the MT is used for configuring the MT to serve the backhaul, so this traffic can be considered backhaul traffic.

It should be noted that, in the IAB scenario, the UL/DL paradigm is changed, compared to the non-IAB case. Namely, the transmission of an IAB node, which is an NN, is not necessarily always considered as a DL transmission. For example, the situation where an IAB node transmits to its parent node could also be considered as an UL transmission, because the data is sent towards the donor node.

NR TDD configuration

At least in the initial release, the IAB networks will leverage TDD communications. In general, NR supports semi-static TDD UL/DL configurations by cell-specific RRC signaling (TDD- UL-DL-ConfigurationCommon in SIB1).

Besides the cell-specific TDD UL/DL configuration via TDD-UL-DL- ConfigurationCommon, a UE can be additionally configured by a UE-specific RRC signaling (TDD- UL-DL-ConfigDedicated) to override only the flexible symbols provided in the cell-specific semi- static TDD configuration.

In addition, NR supports dynamic TDD, that is, dynamic signalling of the DL, flexible, and UL allocation on symbol level for one or multiple slots to a group of UEs by using a Slot Format Indicator (SFI) in the Downlink Control Information (DCI) carried on a group-common PDCCH (DCI Format 2_0). The SFI field in a DCI format 2_0 indicates a group of UEs, a slot format for each slot in a number of slots starting from a slot where the DCI format 2_0 is detected.

A slot format is identified by a corresponding format index as provided in Table 11.1.1-1 of 3GPP TS 38.213, where ‘D’ denotes a downlink symbol, ‘U’ denotes an uplink symbol, and ‘F’ denotes a flexible symbol.

The support for dynamic TDD enables NR to maximally utilize available radio resource in the most efficient way for both traffic directions. Although dynamic TDD brings significant performance gain at low to medium loads, the performance benefits become smaller as the traffic load increases due to the CLI. As shown in FIG. 4, if two cells have different traffic directions, UE1 in DL experiences very strong interference from UE2 which can be closer than the serving NN1. From NN2 in UL perspective, NN2 will also experience interference from NN1 since NN1 is transmitting (DL). CLI is the main impediment to performance gains from dynamic TDD operation at higher loads as compared to static TDD. Most solutions to minimize the CLI involve signaling between NNs in order to exchange information regarding the sources and levels of interference in the operator network.

The situation can also be illustrated on symbol level where the different NNs use different transmission directions in different symbols, see FIG. 5, assuming that in a given slot, the format index 48 is configured for the UEs in NN1 and the format index 49 is configured for the UEs in NN2. The situation shown in FIG. 4 occurs in symbol index 2, 3, 9 and 10 in FIG. 5.

As mentioned earlier, the DL/UL paradigm for the conventional case does not necessarily hold for the IAB case. In the IAB context, the CLI scenario is the one where a transmitting IAB node interferers an IAB node that simultaneously receives in the same resources. As explained earlier, these resources cannot be merely classified as UL or DL. Instead, the correct classification is: ‘transmission’ and ‘reception’.

Cross-Link Interference Management Standardization

One solution to mitigate the CLI is to let different network nodes to dynamically exchange their intended DL/UL transmission direction configurations via backhaul signaling. For instance, the intended DL/UL transmission (Tx) direction configuration can include the parameters such as the periodicity, the numerology, the slot format for each slot within a period, etc., where this intended DL/UL Tx direction configuration is repeatedly applied until it is newly updated.

This method can provide a network node with very detailed information on the intended dynamic TDD pattern to be used in the neighboring nodes. However, this solution requires significant amount of information exchange via backhaul, which may significantly increase the backhaul signaling load. Moreover, depending on the traffic situations in a network node, the network node may adapt its TDD configuration dynamically, where the updates also need to be communicated to other network nodes. This puts significant requirements on the backhaul latency as well. Hence, dynamic exchange of intended DL/UL transmission configurations among network nodes via backhaul signaling is neither feasible nor reliable.

In Rel-16, 3GPP has standardized the exchange of semi-static intended TDD UL/DL configurations between neighboring gNBs or gNB-DUs (via their respective gNB-CUs), where the intended TDD pattern contains explicit indications of UL and DL slots and symbols. The slots/symbols whose allocation is not explicitly indicated are considered ‘not available’ and are subject to dynamic, short-term scheduling decisions of the corresponding node. The intended TDD pattern is conveyed in the Information Element (IE) called Intended TDD DL-UL Configuration, which is introduced into the 3GPP TS 38.423 and 3GPP TS 38.473 specifications.

In particular, the newly introduced Intended TDD DL-UL Configuration is included in the Served Cell Information IE, which is sent from the gNB-DU to the gNB-CU inside either in the F1 SETUP REQUEST or the GNB-DU CONFIGURATION UPDATE messages. The gNB-CU then forwards the Intended TDD DL-UL Configuration IE to the nodes that are in control of the cells that are neighboring the cells whose resources are indicated inside the IE. The gNB-CU is capable of identifying the appropriate recipients of the Intended TDD DL-UL Configuration IE because it has a knowledge of neighbor relations of its cells.

Several scenarios are possible with respect to the gNB-CU forwarding the Intended TDD DL- UL Configuration:

- If the neighboring cells are under control of a gNB-DU (or several gNB-DUs) that is controlled by the same gNB-CU as the sending gNB-DU, the gNB-CU forwards the information to the recipient gNB-DU(s) via the F1 interface inside the GNB-CU CONFIGURATION UPDATE message.

- If the recipient gNB-DU is under the control of another gNB-CU, or if the recipient node is a full (i.e. non-split) gNB, the Intended TDD DL-UL Configuration is forwarded from the gNB-CU to the recipient gNB/gNB-CU via the Xn interface, inside the NG-RAN NODE CONFIGURATION UPDATE message. The Intended TDD DL-UL Configuration IE sent over Xn is identical to its F1 counterpart. Two scenarios are possible in this case, depending on the recipient node:
i. If the recipient node is a split gNB, the recipient gNB-CU forwards the Intended TDD DL-UL Configuration via F1 interface to the recipient gNB-DU inside the GNB-CU CONFIGURATION UPDATE message.
ii. If the recipient node is a full gNB, the CLI information has, at this point, reached its destination.
   The contents of the Intended TDD DL-UL Configuration IE can be found in R3-193233, BL CR to TS 38.473 CLI signaling, RAN3#104, May 2019.

F1AP CLI signaling

As mentioned earlier, the Intended TDD DL-UL Configuration is sent from the gNB-DU to the gNB-CU inside the F1 SETUP REQUEST or the GNB-DU CONFIGURATION UPDATE messages, as a part of the Served Cell Information IE, which can be found in R3-193233, BL CR to TS 38.473 CLI signaling, RAN3#104, May 2019.

In the other direction, the gNB-CU sends the intended TDD pattern to the corresponding gNB- DUs inside the GNB-CU CONFIGURATION UPDATE message, as can be seen in 3GPP TS 38.473, section 9.2.1.10. It should be noted that the gNB-CU may coordinate the exchange of intended TDD DL-UL configuration by merging, forwarding and selective forwarding of intended TDD DL-UL configuration(s) between its gNB-DUs, or between its gNB-DUs and other gNBs, gNB-CUs.

XnAP CLI signaling

If the cells that coordinate CLI mitigation are controlled by different gNBs or by gNB-DUs under different gNB-CUs, the Intended TDD DL-UL Configuration is conveyed over the Xn interface between the two gNB-CUs or gNBs or a gNB-CU and gNB. In particular, the Intended TDD DL-UL Configuration is included in the Served Cell Information NR IE, which is sent over the Xn interface inside the NG-RAN NODE CONFIGURATION UPDATE messages. The Served Cell Information NR IE is shown in R3-192212, BL CR to TS 38.423 CLI signaling, RAN3#104, May 2019, or in 3GPP TS 38.423 (see for example section 9.2.2.11).

### SUMMARY

Currently there exists some challenges. As opposed to the conventional (i.e. non-IAB) deployments, where only regular UEs are served over the Uu interface, the IAB nodes also serve (in addition to regular UEs) other IAB nodes, and hence indirectly, their child IAB nodes and connected UEs. This means that the impact of CLI in IAB networks may greatly exceed the impact in the non- IAB case. Namely, the CLI on backhaul resources for intermediate IAB nodes in a topology, may compromise the connectivity for a number of downstream IAB nodes and UEs. Therefore, the backhaul link should be typically provided with higher protection against the CLI compared to the access link. Currently, it is not specified how an IAB node becomes aware of access/backhaul resource allocations of its neighbor nodes because the existing CLI signaling containing DL/UL information does not differentiate between the backhaul and access resources in an IAB network.

Some embodiments allow to overcome or mitigate the challenges as described above.

For example, in addition to the existing CLI signaling mechanisms, the embodiments enable CLI management for IAB nodes by indicating which resources are used for wireless backhaul.

According to one aspect, some embodiments include methods performed by a first network node, such as an IAB donor node or an IAB node. For example, a method may comprise: receiving an indication of resource allocation from a second network node, the indication indicating whether resources are allocated for a backhaul link or an access link; and performing cross-link interference (CLI) management based on the indication of resource allocation. Another method may comprise: determining resources to be allocated to an access link or a backhaul link; and sending an indication of resource allocation to a second network node, the indication indicating the resources determined to be allocated for the backhaul link or the access link.

According to another aspect, some embodiments include a network node (such as an IAB donor node or IAB node) configured, or operable, to perform one or more functionalities (e.g. actions, operations, steps, etc.) as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the network node may comprise one or more functional modules configured to perform one or more functionalities as described herein.

According to another aspect, some embodiments include a non-transitory computer-readable medium storing a computer program product comprising instructions which, upon being executed by processing circuitry (e.g., at least one processor) of the network node, configure the processing circuitry to perform one or more functionalities as described herein.

The advantages/technical benefits of the embodiments are as follows: the embodiments enable CLI management coordination between IAB nodes, by indicating to neighbor nodes which resources are used for wireless backhaul and which are used for UE/MT access, thus reducing the impacts of CLI. Since resources used for backhaul are of higher priority than the resources used for serving regular UEs, they should be protected from CLI with higher priority than the resources that the IAB node uses for serving regular UEs. Since it is most often not possible to fully align the transmissions of neighboring nodes and therefore fully avoid the CLI, the IAB node can, based on the received information, avoid interfering neighboring backhaul resources with highest priority (e.g. by deferring from scheduling on some slots that are used by many neighboring nodes for backhaul).

This summary is not an extensive overview of all contemplated embodiments, and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates a schematic illustration of a Multi-hop deployment in an integrated access and backhaul (IAB) network.

FIG. 2 illustrates IAB terminologies in adjacent hops.

FIG. 3 is a schematic illustration of a Reference diagram for IAB-architectures (according to TR 38.874).

FIG. 4 is a schematic illustration of a TDD GP design.

FIG. 5 illustrates a CLI issue in a NR dynamic TDD in a given slot.

FIG. 6 illustrates an IAB deployment.

FIG. 7 is a flow chart of a method in a network node, in accordance with some embodiments.

FIG. 8 is a flow chart of another method in a network node, in accordance with some embodiments.

FIG. 9 illustrates one example of a wireless communications system in which embodiments of the present disclosure may be implemented.

FIGS. 10 and 11 are block diagrams that illustrate a network node according to some embodiments of the present disclosure.

FIG. 12 illustrates a virtualized environment of a network node, according to some embodiments of the present disclosure.

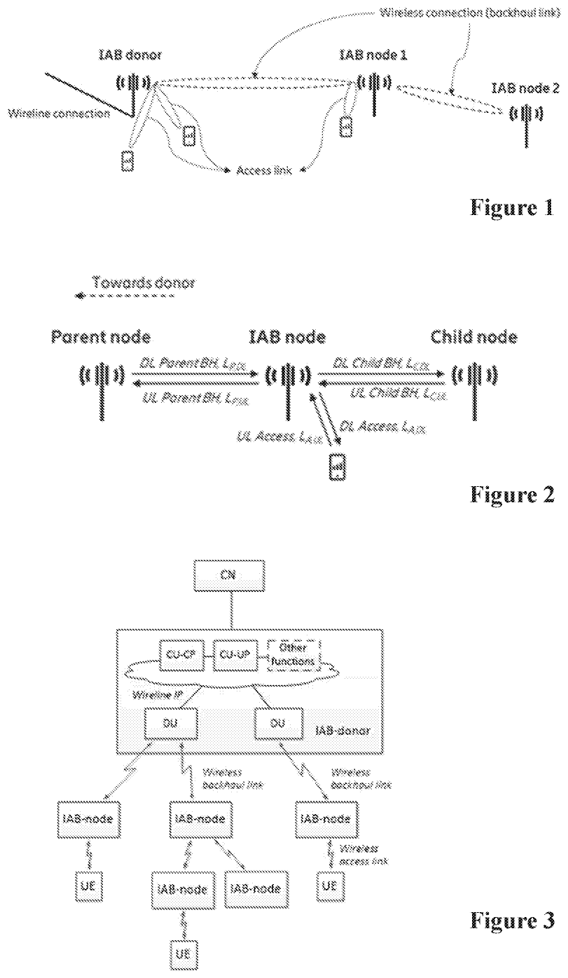

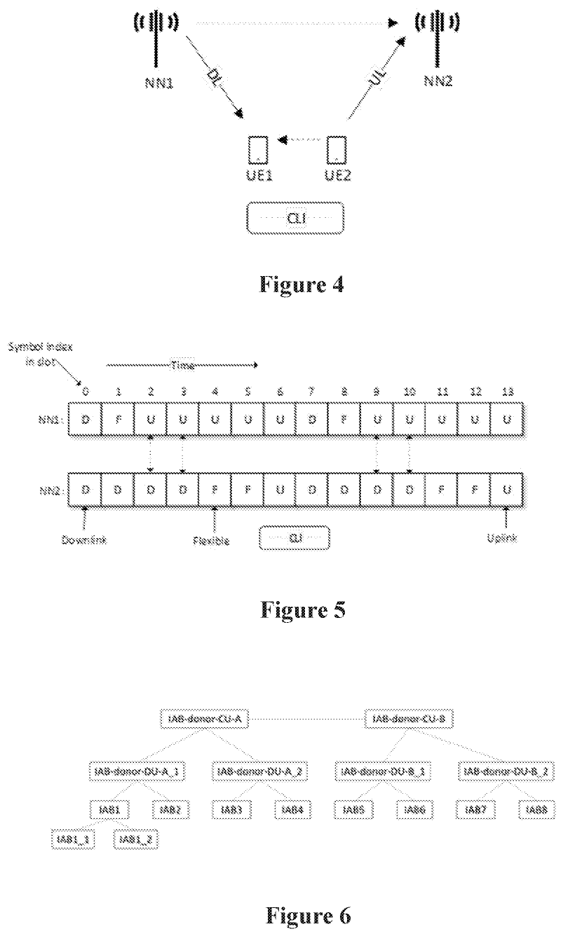

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Generalizations

A network node (NN) can correspond to any type of radio network node or any network node, which communicates with a UE and/or with another network node. Examples of network nodes are NodeB, base station (BS), IAB node, multi-standard radio (MSR) radio node such as MSR BS, eNodeB, gNodeB. MeNB, SeNB, network controller, radio network controller (RNC), base station controller (BSC), road side unit (RSU), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. MSC, MME etc.), O&M, OSS, SON, positioning node (e.g. E-SMLC) etc. The network node may also comprise a test equipment.

A UE can be generalized to correspond to a user terminal, or a network node like a relay node or an IAB node.

An uplink can be generalized to correspond to UL in the access link, and UL in the wireless backhaul link. Similarly, a downlink can be generalized to correspond to DL in the access link, and DL in the wireless backhaul link.

The term radio access technology, or RAT, may refer to any RAT e.g. UTRA, E-UTRA, narrow band internet of things (NB-IoT), WiFi, Bluetooth, next generation RAT (NR), 4G, 5G, etc. Any of the first and the second nodes may support a single or multiple RATs.

The term signal used herein can be any physical signal or physical channel. Examples of downlink physical signals are RSs such as PSS, SSS, CRS, PRS, CSI-RS, DMRS, NRS, NPSS, NSSS, SS, MBSFN RS etc. Examples of uplink physical signals are RSs such as SRS, DMRS etc. The term physical channel (e.g., in the context of channel reception) used herein is also called as 'channel. The physical channel carries higher layer information (e.g. RRC, logical control channel, etc.).

Generally stated, the embodiments provide a mechanism to enable the CLI management for IAB nodes, specifically on how IAB nodes can become aware of the resource utilization of their neighbors, on both access and backhaul links, with the help of their donor CUs. This leads to a more efficient CLI management.

In this disclosure, it is assumed that the gNB-DUs are responsible for configuring resource allocations in their respective cells. However, the methods proposed herein are equally applicable for the case when a donor gNB-CU is responsible for configuring resource allocations in the gNB-DUs. In that case, the donor gNB-CU does not need to get information about the resource allocation from the IAB nodes that it is controlling as it already has that information.

In this disclosure, it is assumed that a certain slot is assigned to backhaul or access. However, the embodiments herein are applicable to the case where some symbols within a given slot can be allocated to the backhaul links while others are given to access links. The only change required is to restructure the IEs exchanged to accommodate such granularity.

It is assumed that the donor gNB-CU has information about which IAB node (or cell of IAB node) is a neighbor of which other IAB node (or cell of IAB node). As such, it is assumed it will be sending only relevant information to the IAB nodes (i.e. only the information about the cells of the IAB nodes that are expected to generate interference to the IAB node receiving the CLI information).

In an ideal case, two neighboring NNs would completely align their TDD patterns, but that is not possible in practice due to e.g. different traffic situations or channel conditions and different NNs, meaning that an alignment and CLI evasion is essentially best-effort. Furthermore, a NN (e.g. an IAB node) can have multiple neighbors, meaning that it should align its transmission pattern with more than one other NN, by merging and analyzing the received neighbor CLI information.

To improve decision making, it is desirable to avoid interfering the backhaul resources of neighbor nodes. As such, it is desirable to give higher priority on avoiding interfering the backhaul resources of neighbor nodes than the neighbor node resources for providing access to regular UEs.

Typically, every IAB cell and every NN will have multiple neighbors, meaning that every NN, when deciding its own allocation, will have to consider incoming intended slot allocations from multiple neighboring nodes. In that respect, important backhaul signals/channels should be scheduled in slots (or symbols) which only experience CLI from a subset of the neighboring cells, while slots that experience CLI from many neighboring cells should preferably not be used for backhaul traffic.

In one embodiment, an indication of which resources are used for backhaul reception by the sender of the coordination message is introduced into F1 and Xn CLI signaling. The backhaul traffic includes all traffic from and to other IAB nodes, while access traffic includes all traffic from and to directly connected UEs.

Let's consider the IAB deployment scenario depicted in FIG. 6. IAB-donor-DU-A_1, IAB- donor-DU-A_2, IAB-donor-DU-B_1 and IAB-donor-DU-B_2, are serving two IAB nodes each, and possibly other UEs directly. These DUs will split their resources between access and backhaul links (i.e. a particular slot can be for access link or backhaul link). Inside each slot, a node can allocate the resources for UL and DL according to one of the possible ways as shown in Table 11.1.1-1 of 3GPP TS 38.213.

An example resource allocation at a donor IAB node (e.g. IAB-donor-DU-A_1) is shown in Table 2 below.

TABLE 2
Example resource allocation by a given
DU which is an IAB donor DU or IAB node

| | | Symbol usage in the slot | | | | | | | | | | | | | |
|---|---|---|---|---|---|---|---|---|---|---|---|---|---|---|---|
| Slot # | Slot usage | 1 | 2 | 3 | 4 | 5 | 6 | 7 | 8 | 9 | 10 | 11 | 12 | 13 | 14 |
| 0 | Access | D | F | U | U | U | U | U | D | F | U | U | U | U | U |
| 1 | Backhaul | D | D | D | D | F | F | U | D | D | D | D | F | F | U |
| 2 | Backhaul | D | D | F | F | F | F | F | F | F | F | F | F | F | F |

The IAB donors can exchange such allocations with their neighboring nodes using an enhanced version of the existing Intended TDD DL-UL Configuration IE. However, it can be appreciated by a person skilled in the art that the resource allocation of Table 2 can be indicated using other IEs and indicators or fields, such as in a MAC Control Element (CE), for example. The indication of resource allocation of Table 2 can be also transmitted in different messages, for example.

The enhancement to the Intended TDD DL-UL Configuration IE comprises an indication of whether a slot is used for backhaul links or access links. One possible realization of the proposed enhancement is shown below, with the enhancement being underlined. For example, a new IE for indicating the type of resources can be included in the Intended TDD DL-UL Configuration. This IE can be a Boolean, where a true value signifies that the slot is allocated to a Backhaul link for IAB (i.e. for communicating with IAB nodes), while a value of FALSE or absence signifies that the slot is used for access links (i.e. for communicating with UEs). In a variation, a false value can signify that the slot is allocated to a Backhaul link for IAB and a true value can signify that the slot is used for access links. Furthermore, the IE could be other than a Boolean variable.

| IE/Group Name | Presence | Range | IE Type and Reference | Semantics Description |
|---|---|---|---|---|
| [...] | | | | |
| >>Slot | Index | M | INTEGER (0..319) | |
| >>Backhaul | M | | BOOLEAN | TRUE signifies that the slot |
| | | | | is allocated to a Backhaul |
| | | | | link for IAB (i.e. for |
| | | | | communicating with IAB |
| | | | | nodes), while value of |
| | | | | FALSE or absence signifies |
| | | | | that the slot is used for |
| | | | | access links (i.e. for |
| | | | | communicating with UEs) |
| >>CHOICE Symbol | M | | | |
| Allocation in Slot | | | | |
| [symbol] | | | | |

It should be noted that even though IAB nodes are communicating with their parent via the backhaul links, it is the parent that is responsible for the resource utilization of these backhaul links because the IAB nodes are connecting to their parent using their MT functionality (which is UE-like, and in the legacy case it is the NN that allocates resources for the UE). This can be generalized to the entire IAB topology: for every parent-child IAB node pair, the parent is responsible for resource utilization on the link towards the child, while the child node is responsible for resource utilization on links towards its children and its directly connected UEs. The resource allocation configuration can be decided either in a distributed fashion by the DU part of each IAB node, or it can be provided by the donor gNB-CU in a centralized fashion. Even though the distributed way of resource allocation configuration is assumed in this disclosure, the embodiments are equally applicable for the centralized case. The IAB nodes can use the structure/indication described above to indicate their backhaul/access resource utilization to their neighbors.

It should be noted that since the parents IAB node are also IAB nodes and the donor gNB- CU has that information (i.e. which node is the parent of which), it is up to the gNB-CU to decide if the parent node's resource allocation is provided to a child IAB node as part of the CLI information that child IAB node receives (e.g. if the parent node's transmission towards the child is supposed to interfere with the child node's transmission to its own child nodes).

As implementation examples, the enhanced Intended TDD DL-UL Configuration IE containing the indication of which resources are allocated to backhaul links and which resources are allocated to access links can be exchanged between a gNB-DU and a gNB-CU (or between an IAB node and its CU) during the F1 setup procedure. For example, the F1 SETUP REQUEST message may comprise the indication of resources allocated to access links or backhaul links. When receiving this indication, the gNB-CU shall use the received information for Cross Link Interference management. For example, the gNB-CU may merge the information/content of the enhanced Intended TDD DL-UL Configuration IE received from two or more gNB-DUs and forward the merged information to the appropriate recipient(s). The gNB-CU shall consider the received IE content valid until reception of an update of the IE for the same cell(s).

In the same way, during the gNB-DU configuration update, the GNB-DU CONFIGURATION UPDATE message may also include the enhanced Intended TDD DL-UL Configuration IE, i.e. the indication of resources allocated to access links or backhaul links. The GNB-DU CONFIGURATION UPDATE message can be sent by the gNB-DU to the gNB-CU. The receiving gNB-DU shall use the received information/indication for CLI management. The gNB-DU shall consider the received IE content valid until reception of an update of the IE for the same cell(s). Alternatively, a GNB-CU CONFIGURATION UPDATE message can be sent by the gNB-CU to the gNB-DU (i.e. CU forwards the incoming content from other DUs/CUs or gNBs to the DU).

The GNB-DU CONFIGURATION UPDATE is sent from a DU to a CU (or an IAB node to its CU). To forward the information to another IAB node, the CU needs to re-pack the Intended TDD DL-UL Configuration IE into the GNB-CU CONFIGURATION UPDATE (if the recipient IAB node is under the same CU), or in the XN SETUP REQUEST/XN SETUP RESPONSE or NG-RAN CONFIGURATION UPDATE (sent between two CUs or between a CU and a gNB), if the recipient IAB node is under another CU, in which case the recipient CU merges all relevant information and re-packs it into GNB-CU CONFIGURATION UPDATE to send it to the recipient IAB node. So, two IAB nodes (and two gNB-DUs in the legacy case) cannot send CLI information to each other directly — the communication always has to go via the CU. If both IAB nodes belong to the same CU, the message will go via that CU (and transparently via all the IAB nodes between the sender IAB node and CU, and between the CU and the recipient IAB node). If two IAB nodes belong to two different CUs, then the message passes via both CUs (and transparently via all the IAB nodes between the sender IAB node and sender CU, and between the recipient CU and the recipient IAB node).

Furthermore, the enhanced Intended TDD DL-UL Configuration IE containing the indication of which resources are allocated to backhaul links and which resources are allocated to access links can be also exchanged between a first NG-RAN node and a second NG-RAN node during the Xn setup procedure. In this case, the enhanced Intended TDD DL-UL Configuration IE is referred to as the enhanced Intended TDD DL-UL Configuration NR IE.

For example, the Xn SETUP REQUEST message or Xn SETUP RESPONSE message may comprise the indication of resources allocated to access links or backhaul links. The receiving NG- RAN node (either the first node or the second node) should take the indication into account for CLI management with the sending NG-RAN node (either the second node or first node). The receiving NG-RAN node shall consider the received IE/indication (i.e. enhanced Intended TDD DL-UL Configuration NR IE) content valid until reception of an update of the enhanced IE/indication for the same cell(s). In the context of IAB, it is the two gNB-CUs that exchange the Xn messages, containing the enhanced IE (which can also contain the indication of resources allocated to access links or backhaul links) of their affiliated gNB-DUs, on behalf of their affiliated gNB-DUs (i.e. IAB nodes).

In the same way, during the NG-RAN node configuration update between a first NG-RAN node and a second NG-RAN node, the NG-RAN NODE CONFIGURATION UPDATE message may also include the enhanced Intended TDD DL-UL Configuration NR IE, i.e. the indication of resources allocated to access links or backhaul links. The NG-RAN node receiving this IE should take this information/information into account for CLI management with the sending NG-RAN node. The receiving NG-RAN node shall consider the received enhanced Intended TDD DL-UL Configuration NR IE content valid until reception of a new update of the IE for the same NG-RAN node.

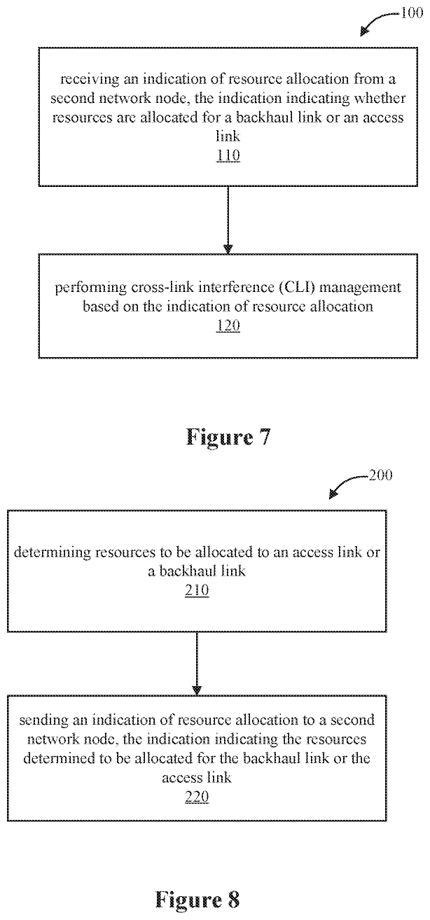

Now turning to FIG. 7, a flow chart illustrating a method 100 in a first network node, according to an embodiment, will be described. The method can be implemented in a network node, such as an IAB node or a gNB-DU. The IAB may comprise a gNB-DU and a MT part, for example, where the MT part is a subset of functionalities of a regular UE. Method 100 comprises:

Step 110: receiving an indication of resource allocation from one or more second network nodes, the indication indicating whether resources are allocated for a backhaul link or an access link;

Step 120: performing CLI management based on the indication of resource allocation.

In some examples, performing CLI management may comprise adapting scheduling of the resources based on neighboring nodes' resource allocations and the received indication.

In some examples, adapting scheduling may comprise deferring scheduling of the resources allocated for the backhaul link that are shared by several neighboring nodes.

In some examples, adapting scheduling may comprise scheduling resources allocated to the backhaul link in a higher priority than scheduling resources allocated to the access link.

In some examples, adapting scheduling may comprise scheduling resources that experience CLI from a smaller number of neighboring nodes for the backhaul link and scheduling resources that experience CLI from a larger number of neighboring nodes for the access link.

In some examples, performing CLI management may comprise reducing transmitting power of the first network node and/or its connected UEs in order to reduce interference to neighboring nodes.

In some examples, performing cross-link interference management may comprise adjusting antennas and properties of antenna beams for reducing interference to neighboring nodes.

In some examples, the resource indications are per cell (one DU can control many cells), so performing CLI management may comprise moving connected children (i.e. their corresponding backhaul resources) between different cells within the same DU.

In some examples, the indication can be contained in an Intended TDD DL-UL Configuration Information Element (IE). In other examples, the indication can be in another IE or in a MAC CE.

In some examples, the indication may comprise a Boolean parameter.

In some examples, a first value of the Boolean parameter can signify that a particular resource is allocated to the backhaul link, and a second value of the Boolean parameter or absence of the parameter can signify that a particular resource is allocated to the access link.

In some examples, the resources may be a slot and a symbol.

In some examples, the indication may refer to a table, such as Table 2, in which different slots are assigned to either the access link or backhaul link and in which each symbol in the different slots is assigned for uplink or downlink transmissions or is denoted as a flexible resource.

In some examples, method 100 may comprise receiving an indication of resource allocated from a plurality of network nodes and performing CLI based on the plurality of received indications of resource allocations.

In some examples, the indication of resource allocation may be exchanged between the first network node and the second network node in a F1setup procedure.

In some examples, the indication of resource allocation may be exchanged between the first network node and the second network node in a gNB configuration update procedure, such as a gNB- CU configuration update or a gNB-DU configuration update procedure.

In some examples the indication of resource allocation may be exchanged between the first network node and the second network node in a Xn setup procedure.

In some examples, the indication of resource allocation may be exchanged between the first network node and the second network node in a NG-RAN node configuration update procedure.

In some examples, the first network node may be an IAB node. Alternatively, the first network node can be a gNB-DU and the second network node can be a gNB-CU.

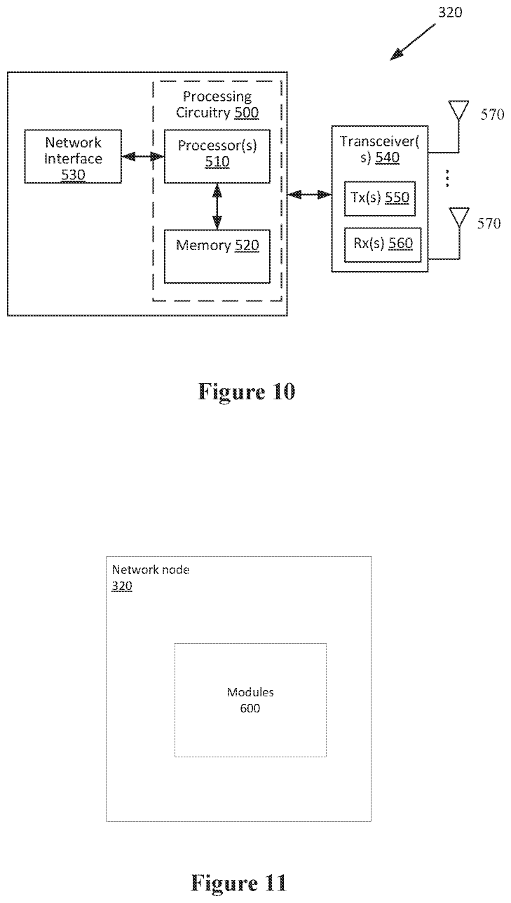

Now turning to FIG. 8, a flow chart illustrating a method 200 in a first network node will be described. The method can be implemented in any network node, e.g. gNB-CU or IAB donor node. The network node may be the network node 320 of FIG. 10. Method 200 comprises:

Step 210: determining resources to be allocated to an access link or a backhaul link.

Step 220: sending an indication of resource allocation to a second network node, the indication indicating the resources determined to be allocated for the backhaul link or the access link.

In some examples, the indication can be used for performing CLI management.

In some examples, the indication can be contained in an Intended TDD DL-UL Configuration Information Element (IE). In some other examples, the indication can be provided in other IEs, or using a MAC CE.

In some examples, the indication may comprise a Boolean parameter.

In some examples, a first value of the Boolean parameter signifies that a particular resource is allocated to the backhaul link, and, a second value of the Boolean parameter or absence of the parameter signifies that a particular resource is allocated to the access link.

In some examples, the resources may comprise a slot or a symbol.

In some examples, the indication may refer to a table, such as Table 2, in which different slots are assigned to either the access link or backhaul link and in which each symbol in the different slots is assigned for uplink or downlink transmissions or is denoted as a flexible resource.

In some examples, the indication of resource allocation may be exchanged between the first network node and the second network node in a F1setup procedure.

In some examples, the indication of resource allocation may be exchanged between the first network node and the second network node in a gNB configuration update procedure.

In some examples, the indication of resource allocation can be exchanged between the first network node and the second network node in a Xn setup procedure.

In some examples, the indication of resource allocation can be exchanged between the first network node and the second network node in a NG-RAN node configuration update procedure.

In some examples, the first network node can be an Integrated Access and Backhaul (IAB) donor node. In some other examples, the first network node can be an gNB-CU and the second network node is a gNB-DU.

In some examples, determining the resources to be allocated to an access link or backhaul link comprising allocating less interfered resources to the backhaul link and more interfered resources to the access link. Furthermore, determining the resources could also comprise allocating the resources to the backhaul/access link according to the current traffic need and channel quality or conditions.

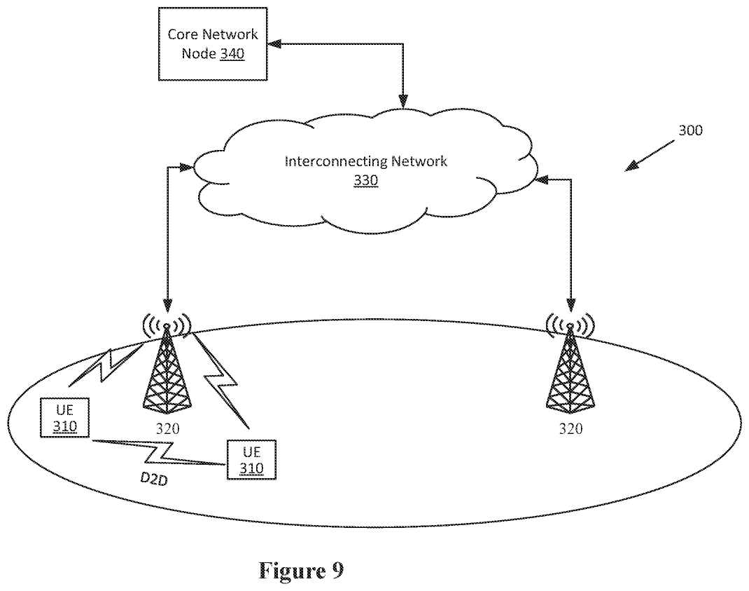

FIG. 9 illustrates an example of a wireless network 300 that may be used for wireless communications. Wireless network 300 includes UEs 310 and a plurality of radio network nodes 320 (e.g., Node Bs (NBs) Radio Network Controllers (RNCs), evolved NBs (eNBs), next generation NB (gNBs), etc.) directly or indirectly connected to a core network 330 which may comprise various core network nodes. The network 300 may use any suitable radio access network (RAN) deployment scenarios, including Universal Mobile Telecommunication System (UNITS) Terrestrial Radio Access Network (UTRAN), and Evolved UNITS Terrestrial Radio Access Network (EUTRAN). UEs 310 may be capable of communicating directly with radio network nodes 320 over a wireless interface. In certain embodiments, UEs may also be capable of communicating with each other via device-to- device (D2D) communication. In certain embodiments, network nodes 320 may also be capable of communicating with each other, e.g. via an interface (e.g. X2 in LTE or other suitable interface).

As an example, UE 310 may communicate with radio network node 320 over a wireless interface. That is, UE 310 may transmit wireless signals to and/or receive wireless signals from radio network node 320. The wireless signals may contain voice traffic, data traffic, control signals, and/or any other suitable information. In some embodiments, an area of wireless signal coverage associated with a radio network node 320 may be referred to as a cell.

It should be noted that a UE may be a wireless device, a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), Universal Serial Bus (USB) dongles, Customer Premises Equipment (CPE) etc.

As examples, the “network node” can be any kind of network node which may comprise of a radio network node such as a radio access node. Some examples have been provided earlier.

In certain embodiments, network nodes 320 may interface with a radio network controller (not shown). The radio network controller may control network nodes 320 and may provide certain radio resource management functions, mobility management functions, and/or other suitable functions. In certain embodiments, the functions of the radio network controller may be included in the network node 320. The radio network controller may interface with the core network node 340. In certain embodiments, the radio network controller may interface with the core network node 340 via the interconnecting network 330.

The interconnecting network 330 may refer to any interconnecting system capable of transmitting audio, video, signals, data, messages, or any combination of the preceding. The interconnecting network 330 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node 340 may manage the establishment of communication sessions and various other functionalities for wireless devices 310. Examples of core network node 340 may include MSC, MME, SGW, PGW, O&M, OSS, SON, positioning node (e.g. E-SMLC), MDT node, etc. Wireless devices 110 may exchange certain signals with the core network node 340 using the non-access stratum layer. In non-access stratum signaling, signals between wireless devices 310 and the core network node 340 may be transparently passed through the radio access network. In certain embodiments, network nodes 320 may interface with one or more other network nodes over an internode interface. For example, network nodes 320 may interface each other over an X2 interface.

Although FIG. 9 illustrates a particular arrangement of network 300, the present disclosure contemplates that the various embodiments described herein may be applied to a variety of networks having any suitable configuration. For example, network 300 may include any suitable number of wireless devices 310 and network nodes 320, as well as any additional elements suitable to support communication between wireless devices or between a wireless device and another communication device (such as a landline telephone). The embodiments may be implemented in any appropriate type of telecommunication system supporting any suitable communication standards and using any suitable components, and are applicable to any radio access technology (RAT) or multi-RAT systems in which the wireless device receives and/or transmits signals (e.g., data). While certain embodiments are described for NR and/or LTE, the embodiments may be applicable to any RAT, such as UTRA, E-UTRA, narrow band internet of things (NB-IoT), WiFi, Bluetooth, next generation RAT (NR, NX), 4G, 5G, L FDD/TDD, etc.

Furthermore, the structure of the network node 320 can have a split structure, where the network node 320 has a centralized unit (CU), and a distributed unit (DU). Also, the network node 320 can be an IAB node or IAB donor node. As illustrated in FIGS. 3 and 9, the IAB donor may have DU and CU functionalities and is connected to a plurality of IAB nodes, for example. Also, the IAB donor may be a non-split node.

FIG. 10 is a schematic block diagram of a network node 320 according to some embodiments. As illustrated, the network node 320 includes a processing circuitry 500 comprising one or more processors 510 (e.g., CPUs, ASICs, FPGAs, and/or the like) and memory 520. The network node also comprises a network interface 530. The network node 320 also includes one or more transceivers 540 that each include one or more transmitters 550 and one or more receivers 560 coupled to one or more antennas 570. In some embodiments, the functionality of the network node 310 described above may be fully or partially implemented in software that is, e.g., stored in the memory 520 and executed by the processor(s) 510. For example, the processor 510 can be configured to perform the method 100 of FIG. 100 or method 200 of FIG. 11. The network node 320 can be an IAB donor node or an IAB node.

FIG. 11 is a schematic block diagram of the network node 320 according to some other embodiments of the present disclosure. The network node 320 includes one or more modules 600, each of which is implemented in software. The module(s) 600 provide the functionality of the network node 320 described herein. The module(s) 600 may comprise, for example, a receiving module operable to perform step 110 of FIG. 7 and a CLI management module operable to perform step 120 of FIG. 7. Furthermore, the module(s) 600 may comprise, for example, a determining module operable to perform step 210 of FIG. 8 and a sending module operable to perform step 220 of FIG. 8.

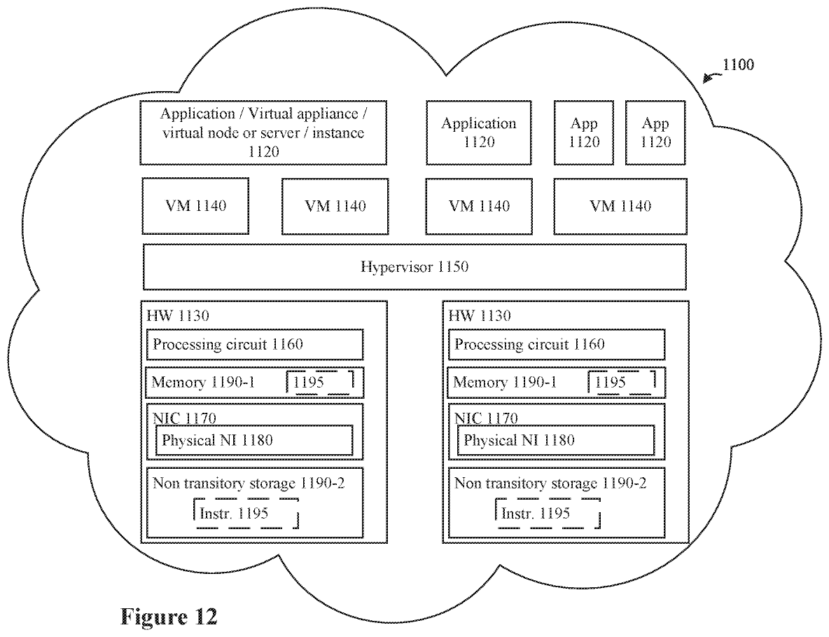

FIG. 12 is a schematic block diagram that illustrates a virtualized embodiment of the wireless device 310 or network node 320, according to some embodiments of the present disclosure. As used herein, a “virtualized” node 1100 is a network node 320 or wireless device 310 in which at least a portion of the functionality of the network node 320 or wireless device 310 is implemented as a virtual component (e.g., via a virtual machine(s) executing on a physical processing node(s) in a network(s)). For example, in FIG. 12, there is provided an instance or a virtual appliance 1120 implementing the methods or parts of the methods of some embodiments. The one or more instance(s) runs in a cloud computing environment 1100. The cloud computing environment provides processing circuits 1130 and memory 1190-1 for the one or more instance(s) or virtual applications 1120. The memory 1190-1 contains instructions 1195 executable by the processing circuit 1160 whereby the instance 1120 is operative to execute the methods or part of the methods described herein in relation to some embodiments.

The cloud computing environment 1100 comprises one or more general-purpose network devices including hardware 1130 comprising a set of one or more processor(s) or processing circuits 1160, which may be commercial off-the-shelf (COTS) processors, dedicated Application Specific Integrated Circuits (ASICs), or any other type of processing circuit including digital or analog hardware components or special purpose processors, and network interface controller(s) (NICs) 1170, also known as network interface cards, which include physical Network Interface 1180. The general- purpose network device also includes non-transitory machine readable storage media 1190-2 having stored therein software and/or instructions 1195 executable by the processor 1160. During operation, the processor(s)/processing circuits 1160 execute the software/instructions 1195 to instantiate a hypervisor 1150, sometimes referred to as a virtual machine monitor (VMM), and one or more virtual machines 1140 that are run by the hypervisor 1150.

A virtual machine 1140 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1140, and that part of the hardware 1130 that executes that virtual machine 1140, be it hardware 1130 dedicated to that virtual machine 1140 and/or time slices of hardware 1130 temporally shared by that virtual machine 1140 with others of the virtual machine(s) 1140, forms a separate virtual network element(s) (VNE).

The hypervisor 1150 may present a virtual operating platform that appears like networking hardware to virtual machine 1140, and the virtual machine 1140 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the instance or virtual application 1120 may be implemented on one or more of the virtual machine(s) 1140, and the implementations may be made differently.

In some embodiments, a carrier comprising the aforementioned computer program product is provided. The carrier is one of an electronic signal, an optical signal, a radio signal, or a computer readable storage medium (e.g., a non-transitory computer readable medium such as memory).

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description, which is defined solely by the appended claims.

1. A method in a first network node, the method comprising:
receiving an indication of resource allocation from a second network node, the indication indicating whether resources are allocated for a backhaul link or an access link;
performing cross-link interference (CLI) management based on the indication of resource allocation.

2. The method of claim 1, wherein performing CLI management comprises adapting scheduling of the resources based on neighboring nodes' resource allocations and the received indication.

3. The method of claim 2, wherein adapting scheduling of the resources comprises deferring scheduling of the resources allocated for the backhaul link that are shared by several neighboring nodes.

4. The method of claim 2, wherein adapting scheduling of the resources comprises scheduling resources allocated to the backhaul link in a higher priority than scheduling resources allocated to the access link.

5. The method of claim 2, wherein adapting scheduling of the resources comprises scheduling resources that experience CLI from a smaller number of neighboring nodes for the backhaul link and scheduling resources that experience CLI from a larger number of neighboring nodes for the access link.

6. The method of claim 1, wherein performing CLI management comprises reducing transmitting power of at least one of the first network node and UEs connected to the first network, in order to reduce interference to neighboring nodes.

7. The method of claim 1, wherein performing CLI management comprises adjusting antennas and properties of antenna beams for reducing interference to neighboring nodes.

8. The method of claim 1, wherein the indication is contained in an Intended TDD DL-UL Configuration Information Element (IE).

9. The method of claim 1, wherein the indication comprises a Boolean parameter.

10. (canceled).

11. (cancelled).

12. (canceled).

13. (cancelled).

14. The method of claim 1, further comprising receiving an indication of resource allocated from a plurality of network nodes and performing CLI based on the plurality of received indications of resource allocations.

15. (canceled).

16. (cancelled).

17. (canceled).

18. (cancelled).

19. (canceled).

20. A first network node comprising a communication interface and processing circuitry connected thereto, the processing circuitry comprising a processor and a memory including instructions, when executed by the processor, cause the first network node to:
receive an indication of resource allocation from a second network node, the indication indicating whether resources are allocated for a backhaul link or an access link;
perform cross-link interference (CLI) management based on the indication of resource allocation.

21. (canceled).

22. A method in a first network node, the method comprising:
determining resources to be allocated to an access link or a backhaul link;
sending an indication of resource allocation to a second network node, the indication indicating the resources determined to be allocated for the backhaul link or the access link.

23. The method of claim 22, wherein the indication is used for performing cross-link interference management.

24. (canceled).

25. The method of claim 22, wherein the indication comprises a Boolean parameter.

26. The method of claim 25, wherein a first value of the Boolean parameter signifies that a particular resource is allocated to the backhaul link.

27. The method of claim 25, wherein a second value of the Boolean parameter or absence of the parameter signifies that a particular resource is allocated to the access link.

28. The method of claim 22, wherein the resources comprise one of a slot and a symbol.

29. The method of claim 22, wherein the indication refers to a table in which different slots are assigned to either the access link or backhaul link and in which each symbol in the different slots is assigned for uplink or downlink transmissions or is denoted as a flexible resource.

30. The method of claim 22, wherein the indication of resource allocation is exchanged between the first network node and the second network node in a F1setup procedure.

31.The method of claim 22, wherein the indication of resource allocation is exchanged between the first network node and the second network node in one of a gNB configuration update procedure, a gNB-CU configuration update procedure and a gNB-DU configuration update procedure.

32. (canceled).

33. (cancelled).

34. (canceled).

35. (cancelled).

36. (cancelled
